(19) United States
(12) Patent Application Publication
(10) Pub. No.: US 2012/0091160 A1
(43) Pub. Date: Apr. 19, 2012

(54) CLOSURE AND METHOD OF FORMING A CLOSURE

(75) Inventor: Jean-Yves Rognard, Marcy-sur-Anse (FR)

(73) Assignee: OBRIST CLOSURES SWITZERLAND GMBH, Reinach (CH)

(21) Appl. No.: 13/281,951

(22) Filed: Oct. 26, 2011

Related U.S. Application Data
(63) Continuation of application No. PCT/GB2010/000896, filed on May 4, 2010.

(30) Foreign Application Priority Data
May 7, 2009 (GB) 0907869.2

(51) Int. Cl. B65D 43/16; B65D 25/40; B29C 65/70; B65D 51/20

(52) U.S. Cl. 220/835; 220/839; 220/257.1; 222/566; 156/69

(57) ABSTRACT

A flip top closure and a method of forming a flip top closure. The flip top closure comprises a base and a lid. The lid being hingedly connected to the base. The lid further comprises a securing portion fixable to the base. The securing portion being operable to secure the lid to the base, such that first opening of the lid breaks a connection between the securing portion and the lid. The lid also comprises a retaining portion, operable to co-operate with the securing portion to retain the lid in a closed position on the base.

### FIELD OF THE INVENTION

The present invention relates to a flip top closure and a method of forming a flip top closure.

### BACKGROUND OF THE INVENTION

Two part closures, for example, those comprising a base and a lid are known. In particular, closures comprising a base and a lid, hingedly connected, also known as flip-top closures, are known.

Typically, after a first opening event, known flip top containers are not arranged such that re-closure of the lid onto the base results in stable retention of the lid in a closed position with respect to the base.

It is an object of the present invention to provide an alternative flip top closure.

### SUMMARY OF THE INVENTION

Accordingly, a first aspect of the present invention provides a flip top closure comprising:

a base; and a lid hingedly connected to said base; said lid further comprising a securing portion fixable to the base and operable to secure the lid to the base such that first opening of the lid breaks a connection between the securing portion and the lid; and a retaining portion, operable to co-operate with the securing portion to retain the lid in a closed position on the base.

The first aspect of the invention recognises that it is possible to provide an arrangement in which a securing portion initially formed as part of a lid may be integrally fixed to a base and thus secure the lid to the base until a first opening event, Furthermore, that securing portion may subsequently co-operate with a retaining portion, also initially formed as part of the lid and retained on the lid after the first opening event, to retain the lid in a closed position on the base.

The flip top closure may be moulded from a suitable plastics material. Moulding is a particularly efficient way to manufacture a closure in accordance with the first aspect of the present invention.

The securing portion may be fixed to the base by a welding process. The welding process may be a suitable plastics welding process. Affixing the securing portion of the lid to the base by a suitable welding process allows efficient manufacture of a closure initially secured in a closed position.

In one embodiment, the retaining portion is operable to emit an audible sound when pushed into co-operation with the securing portion to retain the lid in a closed position on the base. Arranging the retaining portion and securing portion such that an audible sound is emitted when they are pushed into a stable closed position provides positive reinforcement to a user that the lid is retained in the closed position on the base. Various arrangements of the retaining and securing portion are possible to achieve emission of an audible sound, including, for example, one or both of those portions requiring some degree of deformation to move past the other until a stable closed position is reached and a return to an undeformed position is possible.

In one embodiment, the retaining portion comprises a surface defining an aperture. In one embodiment, the securing portion comprises a member shaped to fit substantially within the aperture. In one embodiment, the retaining portion comprises a substantially D-shaped loop. In one embodiment, the securing portion comprises a member shaped to fit within the D-shaped loop. Forming the retaining portion and securing in such a way that the retaining portion of the lid substantially surrounds the securing portion ensures that when the securing portion is fixed to the base, the lid is integrally held to the base and may not be opened until a connection between the securing portion and lid is broken.

In one embodiment the securing portion is initially connected to the retaining portion by a frangible web.

In one embodiment, the lid further comprises a tamper evident portion frangibly connected to the securing portion. The tamper evident portion may be held to the securing portion by a frangible web. The tamper evident portion may be frangibly connected to the retaining portion by a frangible web. In one embodiment, the tamper evident portion comprises a strip, at least one side of which is frangibly connected to the lid. The tamper evident portion may be connected to both the securing portion and the retaining portion by a frangible web.

Provision of a tamper evident portion may allow a user to more easily identify that a first opening event of the closure has occurred. Provision of a suitable tamper evident portion may allow a user to more easily open the lid once the tamper evident portion has been removed or broken away from the securing portion.

In one embodiment, the tamper evident portion further comprises a gripping element. Provision of a gripping element may assist a user in removal of the tamper evident portion from the closure, thereby allowing first opening to occur. The gripping element may comprise a series of ribs. In one embodiment, the gripping element comprises a protrusion. The protrusion may be provided on an inner surface of the gripping element. Such an arrangement helps to lift, or push the gripping element away from a flush arrangement against the base, thereby allowing a user to more simply grasp the tamper evident portion.

In one embodiment, the base further includes a spout portion. In one embodiment, the spout portion comprises a rim, said rim being lowered and chamfered adjacent a hinged connection between the lid and base. Lowering and chamfering the rim of a spout in this way makes it more comfortable for a user to drink directly from the spout without feeling the spout is obstructing their mouth.

In one embodiment, the lid and base are hingedly connected by two straps. Such an arrangement may assist manufacture.

A second aspect of the present invention provides a method of forming a flip top closure comprising:

moulding, in an open position, a closure comprising a base and a lid, said lid being hingedly connected to said base;

the lid comprising a securing portion operable to secure the lid to the base, and a retaining portion, operable to co-operate with the securing portion to retain the lid in a closed position on the base;

moving the lid from the open position to a closed position;

fixing the securing portion on the lid to the base to secure the lid to the base, such that a first opening of the lid breaks a connection between the securing portion and the lid.

The second aspect of the present invention provides an efficient method of manufacturing a closure in accordance with the first aspect of the present invention.

In one embodiment, the moulding step comprises a plastics moulding process. In one embodiment, the moulding step comprises a plastics injection moulding process.

In one embodiment, the fixing step comprises gluing the securing portion provided on the lid to the base. In one embodiment, the fixing step comprises welding the securing portion provided on the lid to the base.

Further particular and preferred aspects of the present invention are set out in the accompanying independent and dependent claims. Features of the dependent claims may be combined with the features of the independent claims as appropriate, and in combinations other than those explicitly set out in the claims.

### BRIEF DESCRIPTION OF THE DRAWINGS

Embodiments of the present invention will now be described further, with reference to the accompanying drawings, in which:

FIG. 1 is a perspective view of a first closure according to the present invention, shown as fitted to a container;

FIG. 2 is a perspective view of the closure of FIG. 1, shown after a first opening event;

FIG. 3 is a side elevation of the closure of FIGS. 1 and 2, shown in an as-moulded condition;

FIG. 4 is a side elevation of the closure of FIG. 3 shown closed prior to a first opening event;

FIG. 5 is a side elevation of the closure of FIG. 4 shown in an open position;

FIG. 6 is a cut away perspective view of the closure shown in FIGS. 1 to 5;

FIG. 7 is a detailed perspective view of part of a lid of the closure shown in FIG. 6;

FIG. 8a is a perspective view of a second closure according to the present invention, shown as fitted to a container;

FIG. 8b is a perspective view of the closure of FIG. 8a, shown in a closed position after a first opening event;

FIG. 9a is a perspective view of a third closure according to the present invention, shown as fitted to a container; and

FIG. 9b is a perspective view of the closure of FIG. 9a, shown in an open position after a first opening event.

### DESCRIPTION OF THE EMBODIMENTS

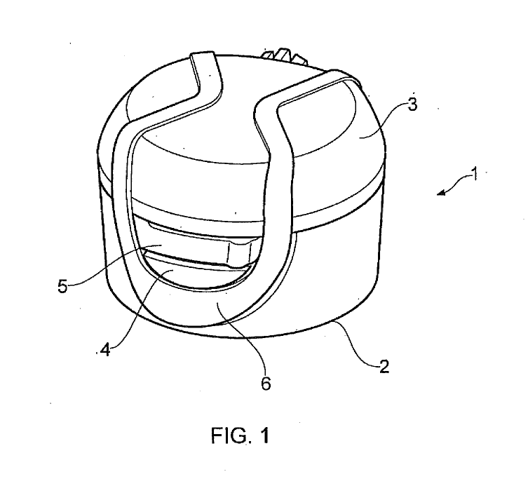

FIG. 1 is a perspective view of a first closure 1 according to the present invention, shown as it may be fitted to a container. The closure 1 comprises a substantially cylindrical base 2 and a lid 3. The lid 3 further comprises a securing portion 4, a tamper evident strip 5 and a retaining portion 6. The securing portion 4 takes the form of an approximately half moon shaped member. The retaining portion 6 takes the form of a substantially d-shaped hook, including an approximately half moon shaped aperture. The securing portion 4 is housed within the aperture formed by the d-shaped hook of the retaining portion 6.

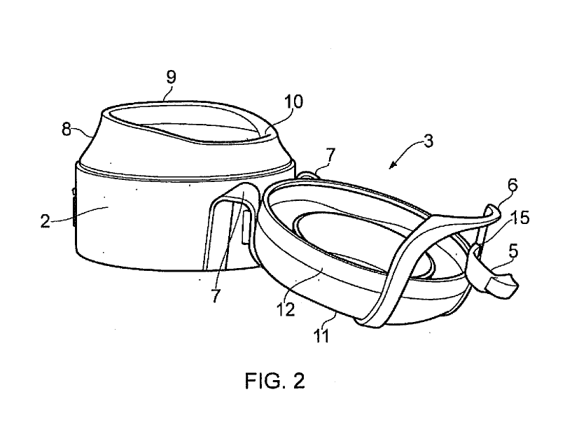

FIG. 2 is a perspective view of the closure of FIG. 1, shown after a first opening event. The structure of a base and lid can be seen in more detail. FIG. 2 shows how the base 2 and lid 3 are connected by straps 7 which form a hinge extending from the base to the lid. The base 2 comprises a generally cylindrical lower section which continues at one end into a substantially frusto conical pouring spout 8. The spout 8 includes a rim 9. The rim has a lower section 10 adjacent the hinge 7.

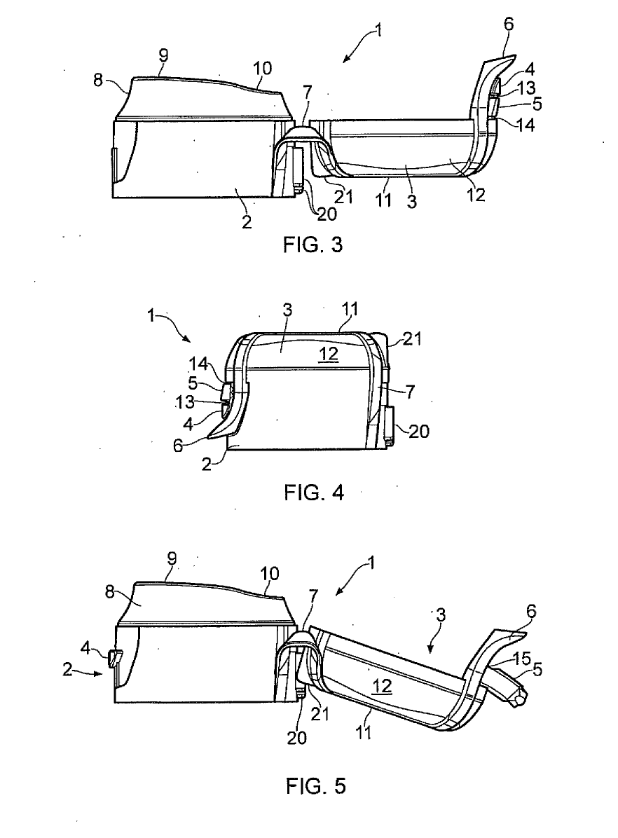

The lid 3 can be seen in more detail in FIG. 2 and comprises a substantially circular top plate 11 and a curved sidewall 12 which extends from the periphery of the plate 11. At the front of the sidewall 12, the retaining portion 6 (in the form of a d-shaped hook) depends. In the embodiment shown in FIG. 2, it can be seen that the tamper evident strip 5 is carried, after the first opening event, by the d-shaped hook 6. FIG. 3 is a side elevation of the closure 1 shown in FIGS. 1 and 2. FIG. 3 shows that closure in an as moulded condition. FIG. 4 is a side elevation of the closure FIG. 3 shown closed, prior to a first opening event, and FIG. 5 is a side elevation of the closure of FIG. 4 shown in an open position after the first opening event.

FIG. 3 shows the closure in the as moulded' condition. The securing portion 4 and the welding portion 5 are moulded to form part of the lid. In this as moulded position, the welding portion 4 is held to the tamper evident strip 5 by a frangible web 13. Frangible web 13 may simply comprise a thinned strip of plastics material. Tamper evident portion 5 is held to the lid 3 by the frangible web 14. Frangible web 14 may also be formed by thinning a strip of plastics material. It can therefore be seen that the welding portion 4 is secured to the lid 3.

Following moulding, the lid 3 is closed onto the base 2 as shown in FIG. 4. Once in the closed position, the securing portion 4 is welded by an appropriate plastics welding technique, onto the lower portion of the base 2. The tamper evident strip 5 is not welded to the base 2. The frangible webs 13 and 14 remain intact after the closing and welding process. Once the securing portion 4 is welded to the base 2 it can thus be seen that the lid is integrally secured in place on the base by the process of welding the securing portion to the base. The closure may be affixed to a container in this condition.

In order to open the lid 3, the tamper evident strip is torn away from the securing portion 4. The frangible web 13 and, in this embodiment the frangible web 14, is broken therefore breaking the connection between the lid and the securing portion 4. Once that connection is broken, it is possible for a user to move the retaining portion 6 away from the body 2 and past the securing portion 4 to open the closure.

In this embodiment, the tamper evident strip 5 is fixedly connected to the d-shape hoop forming the retaining portion 6 along a line 15. The tamper evident strip 5 therefore remains on the retaining portion 6 as shown in FIG. 5.

It can also be seen in FIGS. 3, 4 and 5 that in this embodiment, the lower portion of the base is provided with an array of mutually spaced ribs 20 which extend between the hinge straps 7. Similarly, the sidewall of the lid 12 is provided with an array of mutually spaced ribs 21 which also extend between the hinge straps 7. The rib arrays 20, 21 are staggered, that is to say, that they are not co-linear. In particular, the spacing between the ribs of the arrays 20, 21 is approximately the same as the width of the ribs in the other array.

In use, after the lid 3 is opened for the first time it can be pivoted with respect to the base too. As the lid approaches the base, in the open position, the rib arrays 20, 21 interengage and interdigitate. The width of the ribs in the arrays and the spacing therefore are chosen to provide a tight friction, fit so that the lid 3 is retained stably in an open position and to resist movement away from that stable open position as maybe encouraged by an resilience in hinge straps 7.

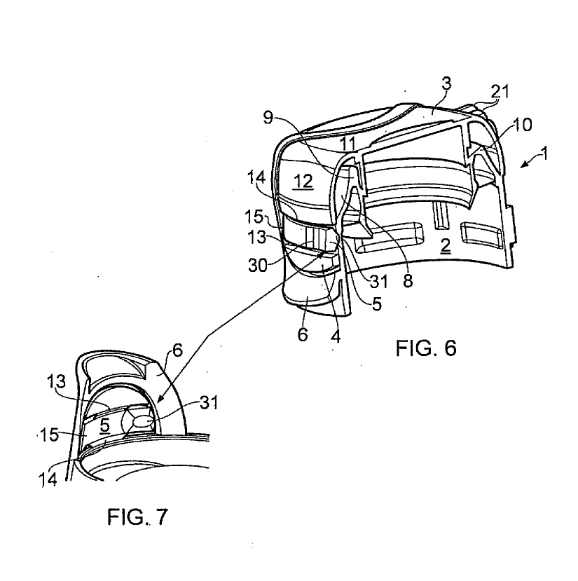

FIG. 6 is a cut away perspective view of the closure shown in FIG. 1 to 5, and FIG. 7 is a detailed perspective view of part of the lid of the closure of FIG. 6. The structure of the tamper evident strip 5 can be seen in more detail in FIGS. 6 and 7. FIG. 6 shows that the tamper evident strip 5 includes a gripping portion. The grip is provided by a series of ribs 30 on the outer surface of the strip. On the inner surface of the tamper evident strip 5 a bump 31 has been provided to aid a user's grip of the tamper evident portion. The bump 31 helps push the gripping portion of the tamper evident strip 5 away from the surface of the base 2 such that a user may more easily grip the tamper evident strip and remove it from the closure to allow opening.

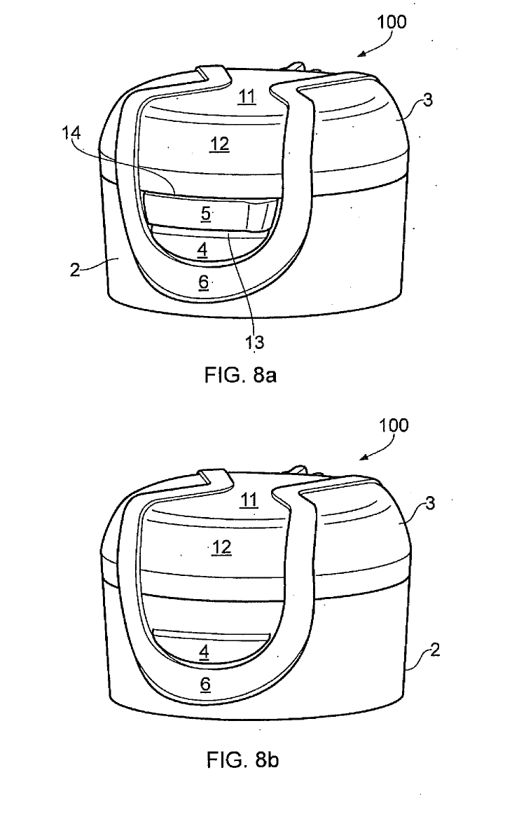

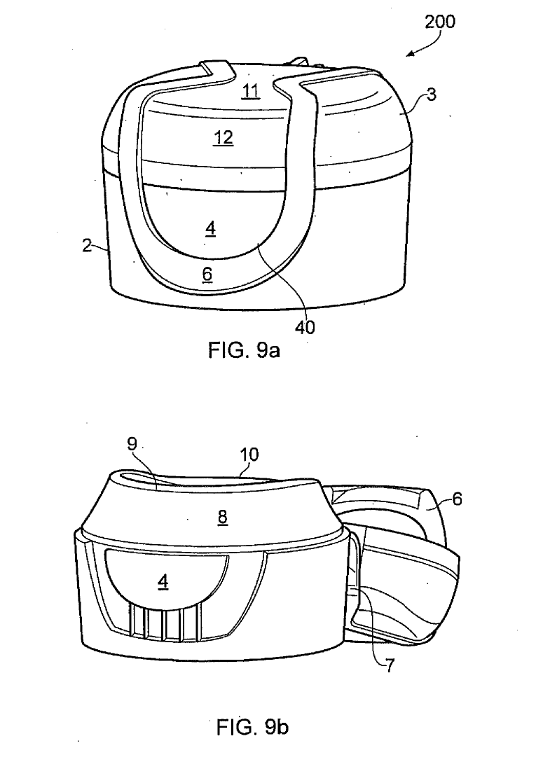

FIG. 8a is a perspective view of second closure 100 according to the present invention shown as it may be fitted to a container. Where appropriate, identical reference numerals have been used in respect of FIGS. 8 and 9 as have been used in relation to the embodiments shown in FIGS. 1 through to 7. The primary difference between the embodiments shown in FIG. 8a and FIG. 8b and a first embodiment shown in FIGS. 1 to 7 is that the tamper evident strip 5 is not held onto the retaining portion 6 by a none frangible portion 15. This means that when frangible portions 13 and 14 are broken to allow first opening of the closure the tamper evident strip 5 is completely removed from the closure. The completely removed arrangement is shown in more detail in FIG. 8b which is a perspective view of the closure of FIG. 8a shown in a closed position after a first opening event.

FIG. 9a is a perspective view of a third closure 200 according to the present invention, shown as it may be fitted to a container. In this embodiment, there is no tamper evident strip 5 and instead the securing portion 4 is frangibly connected along the line 40 to the retaining portion 6. Opening the closure of FIG. 9 requires that the bond between the welding portion 4 and the retaining portion 6 is broken. Once that occurs, as shown in FIG. 9b, the retaining portion 6 attached to the lid may be moved thereby allowing first opening of the closure.

In each of the embodiments the closures 1, 100, and 200, the retaining portion 6 must be pulled slightly away from the base in order for it to pass over the securing portion 4 which is welded to the base. After the first opening event, the retaining portion 6 must be pushed past the retaining portion in order to fully close to closure. The need to gently push the retaining portion 6 past the retaining portion 4 which projects from the side of the base 2 results in an audible sound being emitted once the retaining portion is in the correct position. That sound helps positively reinforce to a user that the closure is retained in the closed position such that the retaining portion 6 together cooperates with the welding portion 4 on the base to retain the lid in a closed position with respect to the base.

Although illustrative embodiments of the invention have been disclosed in detail herein, with reference to the accompanying drawings, it is understood that the invention is not limited to the precise embodiments shown and that various changes and modifications can be effected therein by one skilled in the art without departing from the scope of the invention as defined by the appended claims and their equivalents.

1. A flip top closure comprising:
a base; and
a lid hingedly connected to said base;
said lid further comprising:
a securing portion fixable to the base and operable to secure the lid to the base such that first opening of the lid breaks a connection between the securing portion and the lid; and
a retaining portion, operable to co-operate with the securing portion to retain the lid in a closed position on the base.

2. The closure according to claim 1, wherein the retaining portion is operable to emit an audible sound when pushed into co-operation with the securing portion to retain the lid in a closed position on the base.

3. The closure according to claim 1, wherein the retaining portion comprises a substantially D-shaped loop.

4. The closure according to claim 3, wherein the securing portion comprises a member shaped to fit within the D-shaped loop.

5. The closure according to claim 1, wherein the lid further comprises a tamper evident portion frangibly connected to the securing portion.

6. The closure according to claim 5, wherein the tamper evident portion comprises a strip, at least one side of which is frangibly connected to the lid.

7. The closure according to claim 5, wherein the tamper evident portion further comprises a gripping element.

8. The closure according to claim 7, wherein the gripping element comprises a protrusion.

9. The closure according to claim 1, wherein the base further includes a spout portion.

10. The closure according to claim 9, wherein the spout portion comprises a rim, said rim being lowered and chamfered adjacent a hinged connection between the lid and base.

11. A method of forming a flip top closure comprising:
moulding, in an open position, a closure comprising a base and a lid, said lid being hingedly connected to said base;
the lid comprising a securing portion operable to secure the lid to the base, and a retaining portion, operable to co-operate with the securing portion to retain the lid in a closed position on the base;
moving the lid from the open position to a closed position;
fixing the securing portion on the lid to the base to secure the lid to the base, such that a first opening of the lid breaks a connection between the securing portion and the lid.

12. The method according to claim 11, wherein the fixing step comprises welding the securing portion provided on the lid to the base.

13. The closure substantially as herein before described, with reference to the drawings.

14. The method of forming a closure substantially as herein before described, with reference to the drawings.
